(19) United States
(12) Patent Application Publication
(10) Pub. No.: US 2014/0180873 A1
(43) Pub. Date: Jun. 26, 2014

(54) SHOPPING BY VIRTUAL FITTING

(71) Applicant: Varun Doulat Rijhwani, San Jose, CA (US)

(72) Inventor: Varun Doulat Rijhwani, San Jose, CA (US)

(73) Assignee: eBay Inc., San Jose, CA (US)

(21) Appl. No.: 13/725,209

(22) Filed: Dec. 21, 2012

(51) Int. Cl. G06Q 30/06

(52) U.S. Cl. CPC G06Q 30/0623
USPC 705/26.61

(57) ABSTRACT

A system, article of manufacture, and method is disclosed to enable people to determine how clothing, such as a shirt, will look on a person without the person having to try the shirt on. The buyer takes a photograph of the buyer's best fitting shirt, which may be from front, back and both sides. When the buyer shops for a shirt there is no need to try the shirt on. Instead a photograph of a selected new shirt will be compared with the photograph the shopper has taken of the best fitting shirt. Alternatively, people can fill in the style, brand and size of the shirt on a user interface and the shirt will be compared with the photograph the shopper has previously taken of the best fitting shirt. This can be extended to pants, jeans, skirts and all other articles of men's, women's and children's outfits.

### FIELD

The present disclosure relates generally to information retrieval. In an example embodiment, the disclosure relates to providing in-store shopping based on online images.

### BACKGROUND

eCommerce and other publication systems provide a number of publishing and shopping mechanisms whereby a seller may list or publish information concerning goods or services. A buyer can then express interest in or indicate a desire to purchase such goods or services by, for example, responding to a menu presented as a user interface by the publication system. A buyer, if desired, can combine in-store shopping and on-line shopping for an easier, faster, and more pleasant shopping experience.

### BRIEF DESCRIPTION OF DRAWINGS

The present disclosure is illustrated by way of example and not limitation in the figures of the accompanying drawings, in which like references indicate similar elements and in which:

FIG. 1 is an illustration of a photograph of a user wearing a well-fitting article of clothing;

FIG. 2 is a diagram of a system, in accordance with an embodiment, for providing images and other information relating to a publication system;

FIG. 2A is an illustration of an image of an article of clothing superimposed on the photograph of FIG. 1;

FIG. 3 is a diagram depicting a publication system, in accordance with an embodiment, that identifies items depicted in images and related information relating to items that are desired by a user;

FIG. 4 is a block diagram illustrating an embodiment of a publication system;

FIG. 4A is a block diagram of various modules of an implementation of an image identification module useful in an embodiment;

FIG. 5 is a flow chart illustrating a method useful in an example embodiment;

FIG. 6 is a flow chart illustrating a method useful in an example embodiment;

FIG. 7 is a flow chart illustrating a method useful in an example embodiment; and

FIG. 8 is a block diagram depicting a machine in the example form of a processing system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures and techniques have not been shown in detail.

Embodiments described herein may be considered an app that provides techniques for enabling the shopper to provide images and other information to the network based publication system by way of photographs or other image technologies and, in some instances, other information entered at a user interface. The app would then enable the shopper to receive images and other information back from the publication system for shopping or other purposes. The submission may be by way of a network such as, in one embodiment, the Internet, either by wire coupling or wirelessly. Other networks such as a LAN or other internal or external networks may be used As part of identification functionality, photographs or other appropriate images depicting shoppers wearing an article of clothing chosen by the shoppers as a well-fitting, or a best-fitting, article of clothing for that type of article of clothing, may be stored in an image repository in, for example, the network-based publication system (e.g., an online shopping system). The terms “well-fitting” and “best-fitting” may be used interchangeably to indicate an article of clothing that fits the shopper satisfactorily or perhaps extremely well, depending on the view of the shopper. If further desired as part of identification functionality, sized images depicting a variety of items that may be purchased either online or at a department, or other “bricks and mortar,” store such as Macy's, or other items, may be stored in the image repository. The photograph of the shoppers that are stored images in the image repository may be images that shoppers may submit as a photograph or other appropriate images taken by cell phone, camera, webcam, or even by a laptop with camera capability. Alternatively, the publication system may recognize and identify the submitted image based on the submitted image, or based on the location of the camera that supplied the image submitted with the photograph. Identification and recognition of the image itself may be based on identifying a shopper's name or based on other identifying information. The system may then, after identifying the image, associate the shopper's identity with the shopper's image.

Images depicting a variety of items that may be purchased may be categorized by brand, size, and style information, and/or brand, size, and style photographs, and stored in the image repository. For example, the photograph of the selected item may illustrate a tag showing the brand, style, and size, in one embodiment. Alternatively, dimensions of the items for fitting purposes may also be transmitted to and stored in the image repository. The dimensions may include the waist size and inseam size, or the neck size and the sleeve size, and similar dimensions.

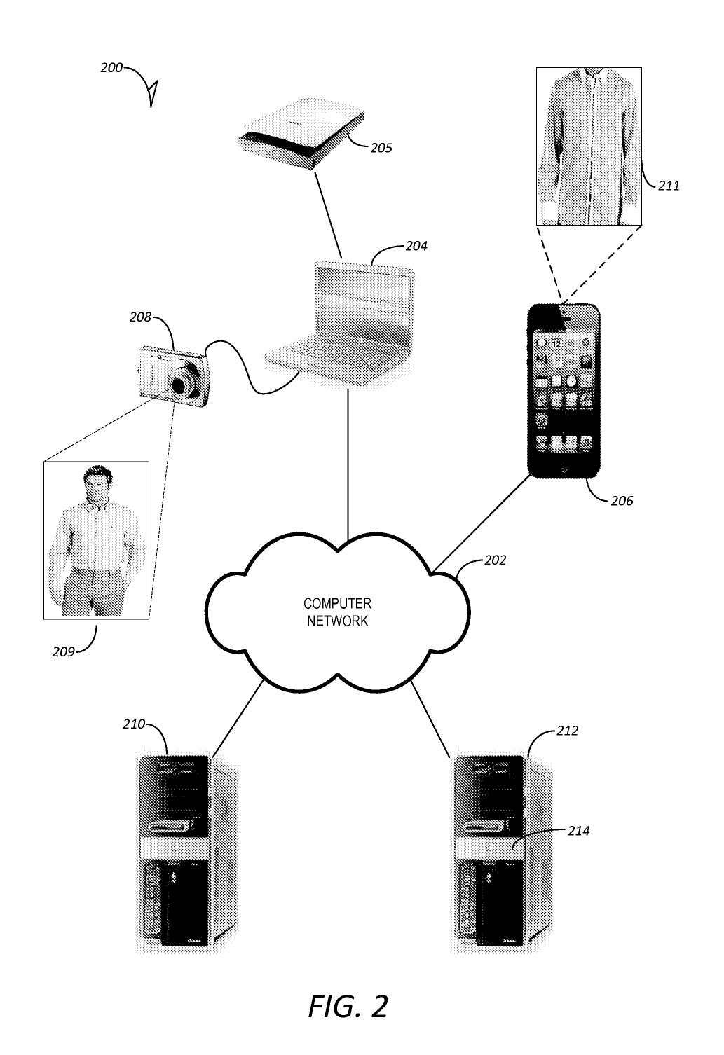

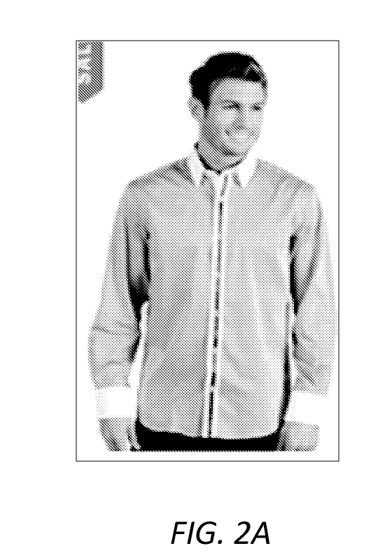

If, for example, a user is a shopper, he or she may register with the publication system by taking photographs of himself or herself in a well-fitting or best-fitting shirt, as one example. The article of clothing could also be any type of clothing such as jacket, blazer, dress slacks, dresses, blouses, jeans, etc. The shopper transmits the photo(s) to the publication system as at 209 of FIG. 2, and the publication system stores them in the above repository, identified and associated with the shopper. The foregoing process may be considered a registration process for the shopper.

At some point the shopper may go shopping at a department store such as, for example, Macy's. The shopper may see a shirt, that he or she likes and then, in an embodiment, takes a photograph of the shirt in the store with a smart phone or other appropriate device. The shopper may then transmit the photograph of the shirt, with appropriate identification of the shopper, and also brand, size, and style information relating to the shirt, to the publication system as at 211 of FIG. 2.

The publication system may then identify the photograph of the shirt that the shopper has taken in the store, or from an alternate image, and retrieve a photograph of the shirt in the appropriate size as identified in the transmitted photograph of the selected shirt. Alternatively, the photograph may be retrieved based on or from brand, size and style information that the shopper may enter in an appropriately designed user interface. The publication system may then retrieve the photograph of the shopper wearing his best-fitting shirt, and superimpose the photograph of the selected shirt on the photograph of the shopper. The superimposed photograph, an example of which is seen in FIG. 2A, is transmitted to the shopper's smart phone or other suitable device for inspection by the shopper without necessarily having to try the shirt on in a fitting room in the department store. The shopper may inspect the superimposition and determine whether the shirt fits well. In the superimposed image of FIG. 2A, the shirt appears to fit well. The shopper may also determine by inspection how the color of the shirt looks on him or her, as superimposed on his or her photograph. Alternately, the shirt might appear too large, which can be observed by inspection. Alternately still, the shirt might appear too small, in which case it would appear as at least partly inside the perimeter of the shopper in the registration photograph when superimposed. In addition, the publication may convert the shirt of 211 to a transparency so that the fit can be seen more clearly when superimposed on the well-fitting shirt of the registration photograph.

Alternatively, only part of the selected shirt, for example a quadrant, may be superimposed onto the shopper's registration photograph. In another embodiment, instead of merely taking a photograph of the shirt as folded, or keying in the particular data about the brand, style, and size, the shopper may actually open the shirt, take a photograph of the shirt, and send a photograph of the shirt to the publication system which may, using data from the selected shirt photograph, superimpose the selected shirt on the registered photograph of the shopper. In yet another embodiment, the publication system may as a matter of operation obtain from each manufacturer their dimensions of clothing, here shirts, for a particular, brand, style, and size. For example, a hypothetical slim fit shirt of style code 0011 will have certain dimensions. The dimension data may be stored in the data base of the publication. In this embodiment the shopper may be asked to enter his or her dimensions as part of the registration process and transmit them to the publication system. Such dimensions may include waist size, inseam size, neck size, shirt sleeve size, and similar dimensions. Subsequently, upon receiving data from the shopper indicating the brand, size and style of shirt, the publication system may then compare the manufacturer dimension data with the shopper's dimension data and send comparative data to the shopper. In this embodiment, the shopper does not have to be in the department store because the brand, size and style can be transmitted to the publication system from any location.

Alternatively, the publication system may produce an image of the shirt from the manufacturer's dimensions of the shirt using well known shirt manufacturing processes.

As another alternative, the publication may transmit the selected shirt's brand, size, and style information to the manufacturer and the manufacturer itself may produce the image of the selected shirt from its own dimensions and transmit the image to the publication system which then superimposes the image on the shopper's registered photograph, as discussed above.

The shopper then has the option of inspecting the returned information, purchasing the shirt and taking it with him from the department store. Or, if the dimension alternative discussed above is used, the purchaser may not need to be in a department store but may make the purchase online instead. If purchasing is done at a department store, the purchasing may be accomplished at the usual on-site purchase and payment area, counter, or kiosk. Alternatively, payment may be made through a payment system such as PayPal, as described in U.S. patent application Ser. No. 13/599,580 entitled SHOPPING LIST CREATOR AND OPTIMIZER, filed Aug. 30, 2012, assigned to the assignee of the present patent, and incorporated herein by reference in its entirety.

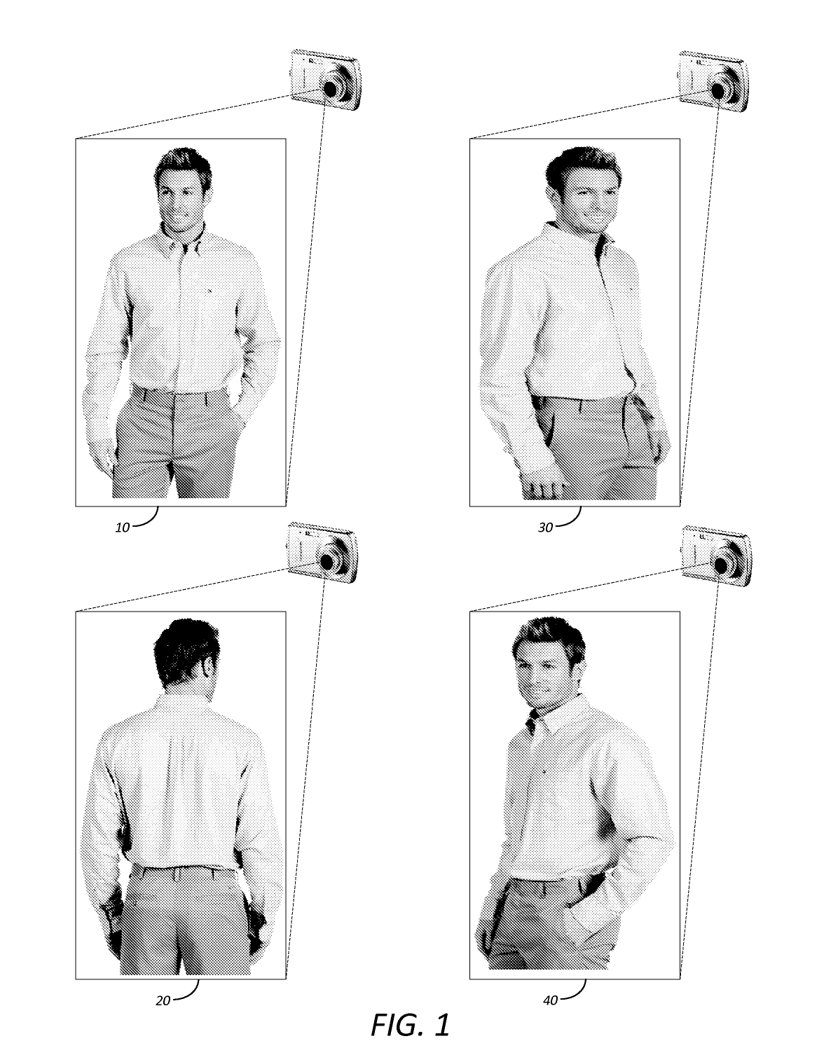

FIG. 1 is an illustration of a shopper taking a photograph of himself wearing a well-fitting shirt. The shopper may take the photograph in three or four views, front 10, rear 20, and side, 30, 40. The photographs may be taken using a digital camera so that they can be transmitted digitally.

FIG, 2 is a diagram depicting a system 200, in accordance with an illustrative embodiment, for identifying items depicted in images. As depicted, the system 200 includes a client processing system, which may a smart phone 206 or other similar device, such as laptop 204 or other computer, a server 210 hosting a variety of services, and another server 212 hosting an item recognition module 214, which are all interconnected by way of a network 202. The computer network 202 is a collection of interconnected processing systems that communicate utilizing wired or wireless mediums. Examples of such networks include Local Area Networks (LANs) and/or Wide-Area Networks (WANs), such as the Internet.

In the example of FIG. 2, a client processing system (e.g., personal computer 204 or smart phone (or other mobile phone, or other appropriate device 206) transmits an image of an item 209 or 211 to the image recognition module 214, which is hosted on the server 212. The image may be captured by a camera built into the mobile phone 206 or by a camera 208, which is configurable to download its stored images to the personal computer 204 (or to the smart phone 206). Further the submitted image could be an already existing photograph such as the photograph of the shopper wearing a well-fitting article of clothing as discussed above and also illustrated in 209, or other images capable of being submitted to the publication system by, for example, upload. Alternatively, the user may locate an image through, for example, the Internet or other image repositories and submit it to the system. Further still, the image could be image 211 of a shirt of the type the shopper would like to purchase, also as discussed above, and uploaded by smart phone 206.

The image recognition module 214 accesses the image from the client processing systems and, as explained in more detail below, identifies the items 209, 211 depicted in the image with an item identifier, which for image 209 may include identification information of the shopper. The item 211 may be, in one embodiment, a photograph of an article of clothing the shopper desires to purchase. An “item identifier,” as used herein, refers, for item 211, to a variety of values (e.g., alphanumeric characters and symbols) that establish the identity of or uniquely identify item 211. For example, the item identifier can be a brand, size, and style information or it may be the image itself In another example, the item identifier can include a barcode value (e.g., Universal Product Code (UPC)) assigned to the item 211. In yet another example, the item identifier can also include a title or description assigned to the item 211.

In an embodiment, the item recognition module 214, which may include a categorization module to categorize the identified image, 209 or 211, may then transmit the item identifier to a service hosted on the server 210 to locate item data. The “item data,” as used herein, refer to a variety of data regarding one or more images, in one embodiment an article of clothing, depicted in image 211, or the data posted or associated with the registered image of the shopper 211 in FIG. 2. Such item data, for example, may be stored with the images 209, 211 or at other locations. It should be appreciated that the item recognition module 214 may access a variety of different services by way of, for example, a web-exposed application program interface (API). In an alternate embodiment, the item recognition module 214 may be embodied with the service itself where, for example, the item recognition module 214 may be hosted in the server 210 with the other services.

The system 200 may also include a global positioning system (not shown) that may be attached to or included in the client processing systems. The client processing systems can transmit the coordinates or location identified by the global positioning system to the services hosted on server 210 and, for example, the services can use the coordinates to locate nearby or other stores that sell the item 211depicted in the image.

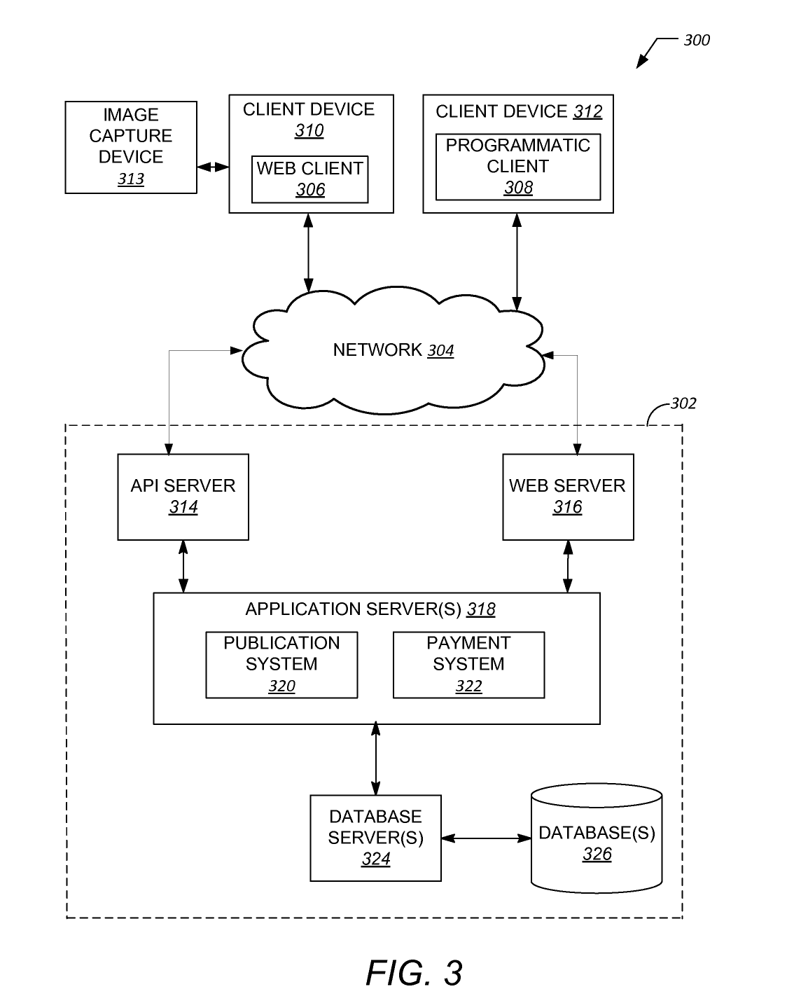

With reference to FIG. 3, an example embodiment of a high-level client-server-based network architecture 300, more detailed then FIG. 2, which may include the servers 210 and 212 of FIG. 2. A networked system 302, in an example form of a network-server-side functionality, is coupled via a communication network 304 (e.g., the Internet, wireless network, cellular network, or a Wide Area Network (WAN)) to one or more client devices 310 and 312. FIG. 3 illustrates, for example, a web client 306 operating via a browser (e.g., such as the INTERNET EXPLORER® browser developed by Microsoft® Corporation of Redmond, Wash. State), and a programmatic client 308 executing on respective client devices 310 and 312.

The client devices 310 and 312 may comprise a smart phone, desktop computer, laptop, or any other communication device that a user may utilize to access the networked system 302. In some embodiments, the client device 310 may comprise or be connectable to an image capture device 313 (e.g., camera, camcorder, or the like). In further embodiments, the client device 310 may comprise one or more of a touch screen, accelerometer, microphone, and GPS device. The client devices 310 and 312 may be a device of an individual user interested in visualizing an item within an environment.

An Application Program Interface (API) server 314 and a web server 316 are coupled to, and provide programmatic and web interfaces respectively to, one or more application servers 318. The application servers 318 host a publication system 320 and a payment processor, or payment system, 322, each of which may comprise one or more modules, applications, or engines, and each of which may be embodied as hardware, software, firmware, or any combination thereof. The application servers 318 are, in turn, coupled to one or more database servers 324 facilitating access to one or more information storage repositories or database(s) 326. The databases 326 may also store user account information of the networked system 302 in accordance with example embodiments.

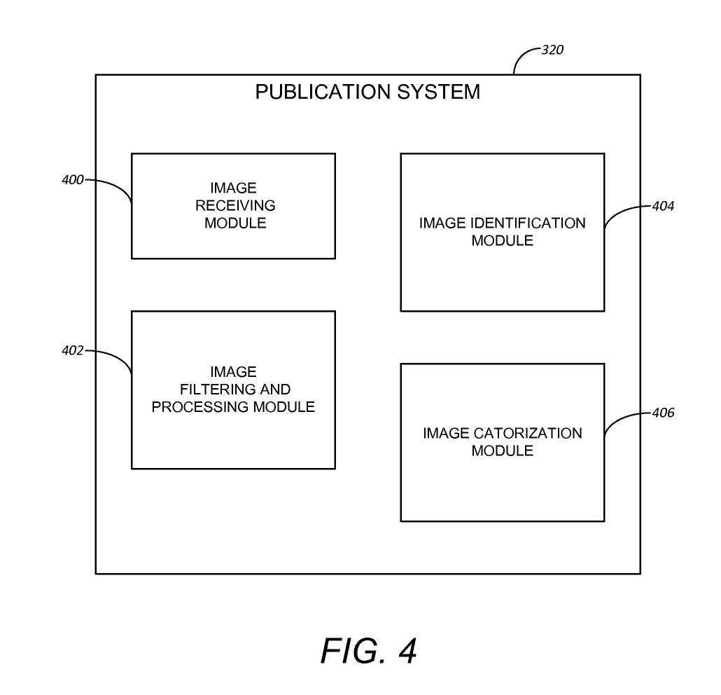

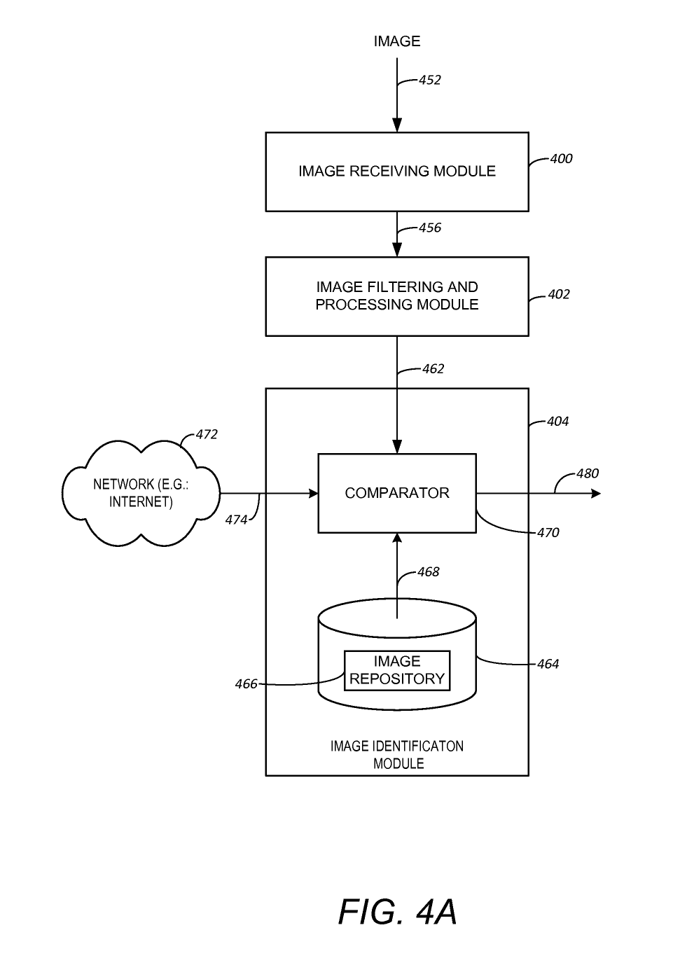

In example embodiments, the publication system 320 publishes content on a network (e.g., Internet) 304. As such, the publication system 320 provides a number of publication functions and services to users that access the networked system 302. The publication system 320 is discussed in more detail in connection with FIG. 4. In example embodiments, the publication system 320 is discussed in terms of a marketplace environment. However, it is noted that the publication system 320 may be associated with a non-marketplace environment such as an informational or social networking environment.

The payment system 322 provides a number of payment services and functions to users. The payment system 322 allows users to accumulate value (e.g., in a commercial currency, such as the U.S. dollar, or a proprietary currency, such as “points”) in their accounts, and then later to redeem the accumulated value for products (e.g., goods or services) that are made available via the publication system 320 or elsewhere on the network 304. The payment system 322 also facilitates payments from a payment mechanism (e.g., a bank account, PayPal™, or credit card) for purchases of items via any type and form of a network-based marketplace.

While the publication system 320 and the payment system 322 are shown in FIG. 3 to both form part of the networked system 302, it will be appreciated that, in alternative embodiments, the payment system 322 may form part of a payment service that is separate and distinct from the networked system 302. Additionally, while the example network architecture 300 of FIG. 3 employs a client-server architecture, a skilled artisan will recognize that the present disclosure is not limited to such an architecture. The example network architecture 300 can equally well find application in, for example, a distributed or peer-to-peer architecture system. The publication system 320 and payment system 322 may also be implemented as standalone systems or standalone software programs operating under separate hardware platforms, which do not necessarily have networking capabilities.

Referring now to FIG, 4, an example block diagram illustrating multiple components that, in one embodiment, are provided within the publication system 320 of the networked system 302 is shown. In one embodiment, the publication system 320 is a marketplace system where items (e.g., goods or services) may be offered for sale. In an alternative embodiment, the publication system 320 is a social networking system or information system. The publication system 320 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 326 via the one or more database servers 324.

In one embodiment, the publication system 320 provides a number of mechanisms whereby the system 320 may publish menus relating to goods or services of a seller or business, a buyer can express interest in or indicate a desire to purchase such goods or services based on an image, and a price can be set for a transaction pertaining to the goods or services. To this end, the publication system 320 may comprise at least one image receiving module 400, one or more image filtering and processing module 402, one or more image identification module 404, and one or more image categorization module 406 as illustrated in FIG. 4.

An image receiver module 400 is an image receiver that receives images that are uploaded to the publication system by a user and that may be identified and categorized by the publication system and then used in retrieving information that, based on the categorization, relate to the image that is desired by the user.

An image filtering and processing module 402 provides well known functionality for filtering and processing image information in order to remove image defects such as, in one embodiment, defects that lead to undesired red-eye or other flash characteristics. This may allow more effective identification of the image.

An image identification module 404 allows identification of the image submitted by the user. As explained in more detail in the above-incorporated application, an item depicted in an image may be identified by matching the image to known images stored in an image repository. In some embodiments, also as explained in the foregoing application, the match may be based on a comparison of the color histograms of the images. In other embodiments, the match may be based on brand, size, and/or style information entered by the user.

An image categorization module 406 allows categorization of images identified by image identification module 404. An example of such image categorization is disclosed in U.S. patent application Ser. No. 11/952,026 entitled “Image Categorization Based on Comparisons between Images” filed on Dec. 6, 2007 and assigned to the assignee of the present application. The foregoing application is hereby incorporated herein by reference in its entirety.

Although the various components of the publication system 320 have been defined in terms of a variety of individual modules and engines, a skilled artisan will recognize that many of the items can be combined or organized in other ways. Alternatively, not all components of the publication system 320 of FIG. 4 may be utilized. Furthermore, not all components of the publication system 320 have been included in FIG. 4. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

FIG. 4A is an illustration of various modules of an implementation of an image identification module useful in an example embodiment image identification module 406 comprises database 464 which includes image repository 466. Database 464 may be included as part of database 326 of FIG. 3. Image repository 466 may be used for storing images 209, 211, of FIG. 2, and related information, which may be received from a shopper, as discussed above, over line 452 at image receiving module 400. The related information may bypass modules 400, 402, and be used directly for accessing desired images from image repository 466 as is well known by those of ordinary skill in the art. The image may be filtered and processed at image filtering and processing module 402 to remove or minimize defects. The filtered image enters image identification module 404 over line 462. The image over line 462 and comparison images from repository 466 are compared in comparator 470. If there is a successful identification, the image identification information is provided over line 480. Also, the images and related information could also be obtained by the user or shopper over the Internet, as illustrated at 472, 474 of FIG. 4A

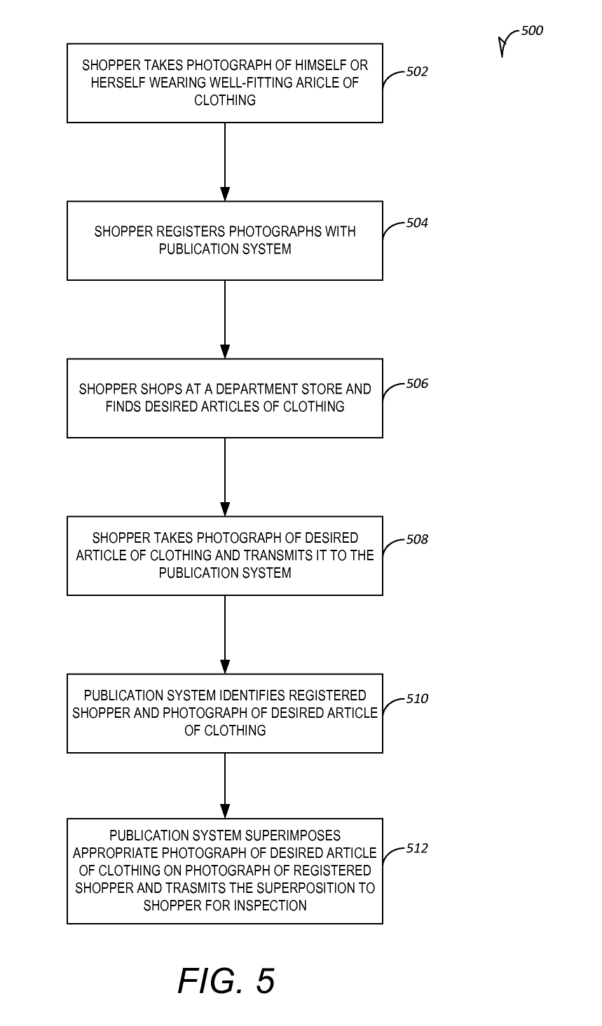

FIG. 5 is a flow chart further illustrating a method according to an embodiment. In operation 502, the shopper takes a photograph of himself or herself wearing a well-fitting article(s) of clothing. At 504 the shopper registers the photograph with appropriate identification with the publication system as in FIG. 1. At 506 the shopper shops at a department store and finds a desired article of clothing. At 508 the shopper takes a photograph of the desired article of clothing and transmits the photograph to the publication system as discussed above and as illustrated at 211 of FIG. 2. The shopper need not necessarily be in the department store but may access the desired article over the Internet such as at eBay as is well known in the art. At 510 the publication system identifies the registered shopper and the photograph of the desired article of clothing. At 512 the publication system superimposes the photograph of the desired article of clothing on the photograph of the registered shopper and transfers the superposition to the shopper for inspection.

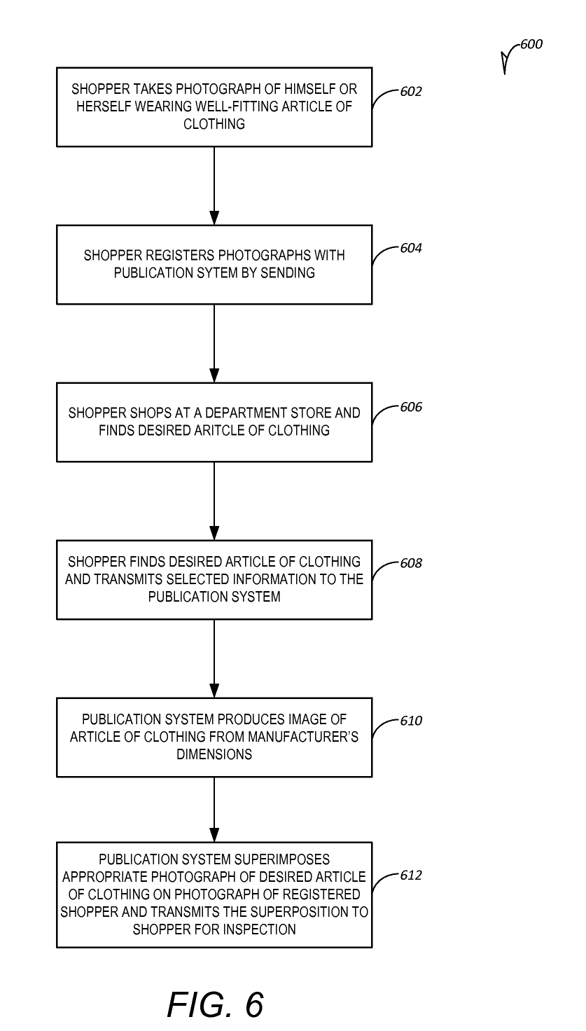

FIG. 6 is a flow chart further illustrating a method according to another embodiment. In operation 602, the shopper takes a photograph(s) of himself or herself wearing a well-fitting article(s) of clothing such as illustrated in FIG. 1. At 604 the shopper registers the photograph with appropriate identification with the publication system as discussed above, and as illustrated at 209 of FIG. 2. The shopper need not necessarily be in the department store but may, if desired, access the desired article over the Internet such as at eBay as is well known in the art. At 606 the shopper shops at a department store and finds a desired article of clothing. At 608 the shopper takes a photograph of the desired article of clothing and transmits the photograph, such as is illustrated at 211 of FIG. 2, to the publication system, along with appropriate brand, size, and style information. At 610 the publication system produces an image of the desired article of clothing from the manufacturer's dimensions of the appropriate size. At 612 the publication system superimposes the photograph of the desired article of clothing on the photograph of the registered shopper and transfers the superposition to the shopper for inspection.

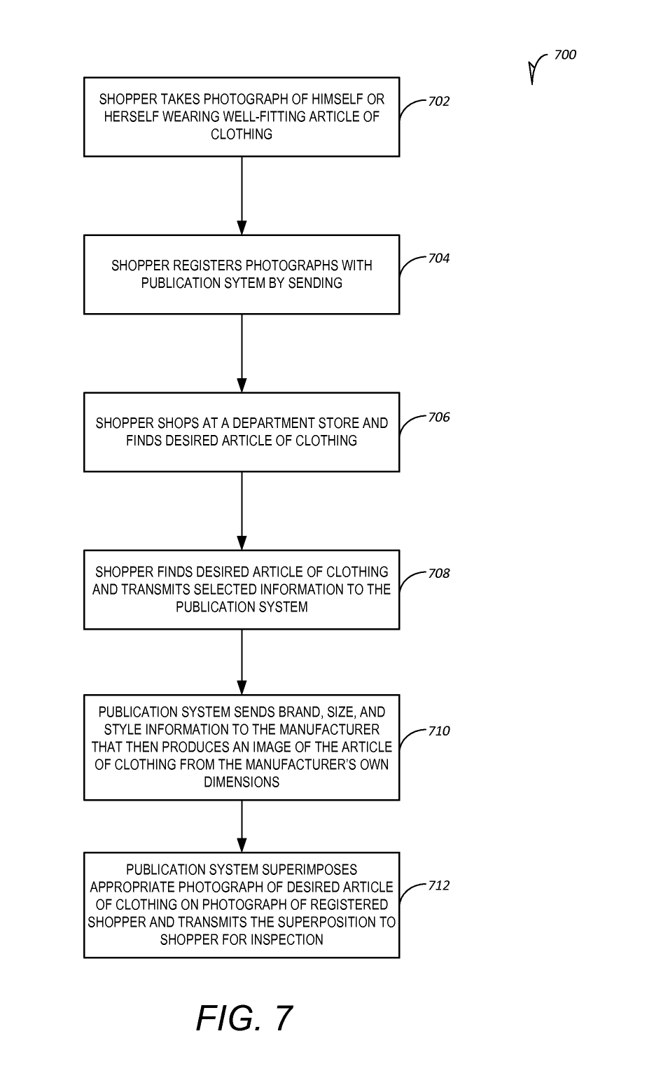

FIG. 7 is a flow chart further illustrating a method according to another embodiment. In operation 702, the shopper takes a photograph of himself or herself wearing a well-fitting article(s) of clothing as illustrated at FIG. 1. At 704 the shopper registers the photograph with appropriate identification with the publication system. At 706 the shopper shops at a department store and finds a desired article of clothing. At 708 the shopper takes a photograph of the desired article of clothing and transmits the photograph to the publication system, along with appropriate brand, size, and style information. At 710 the publication system sends the brand, size, and style information to the manufacturer who produces an image of the article of clothing from the manufacturer's own dimension using well known manufacturing clothing image-generating processes, and sends the image to the publication system. At 712 the publication system superimposes the image of the desired article of clothing on the photograph of the registered shopper and transferred the superposition to the shopper for inspection.

Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Example Machine Architecture and Machine-Readable Medium

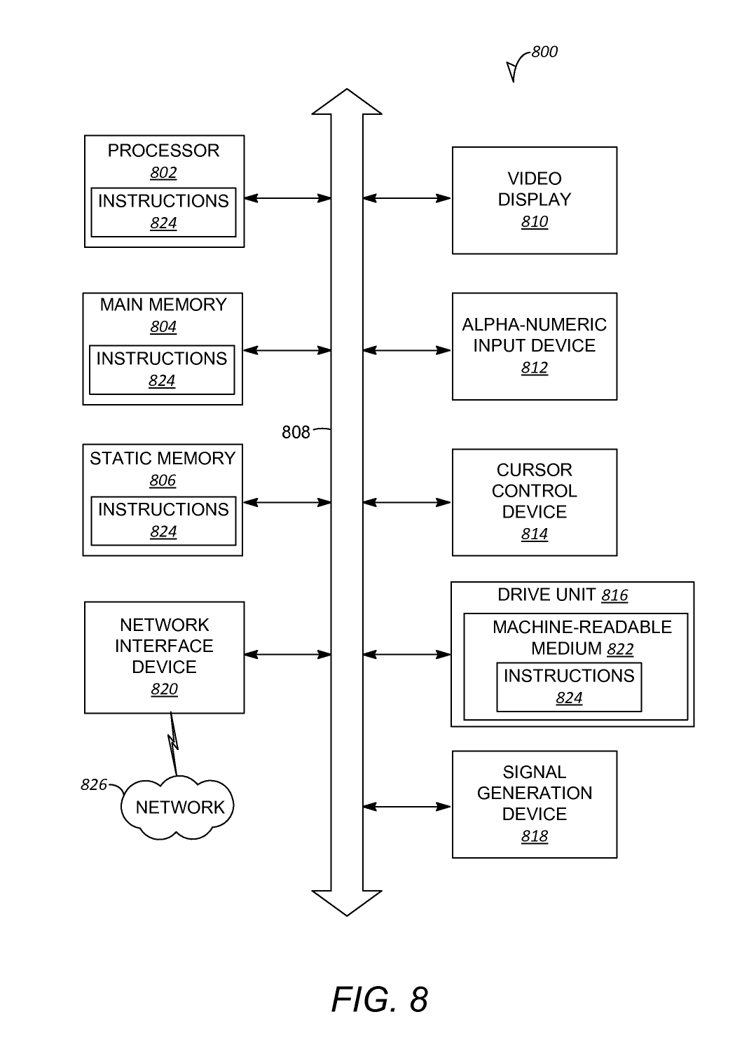

With reference to FIG. 8, an example embodiment extends to a machine in the example form of a computer system 800 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). In example embodiments, the computer system 800 also includes one or more of an alpha-numeric input device 812 (e.g., a keyboard), a user interface (UI) navigation device or cursor control device 814 (e.g., a mouse), a disk drive unit 816, a signal generation device 818 (e.g., a speaker), and a network interface device 820.

Machine-Readable Storage Medium

The disk drive unit 816 includes a machine-readable storage medium 822 on which is stored one or more sets of instructions 824 and data structures (e.g., software instructions) embodying or used by any one or more of the methodologies or functions described herein. The instructions 824 may also reside, completely or at least partially, within the main memory 804 or within the processor 802 during execution thereof by the computer system 800, with the main memory 804 and the processor 802 also constituting machine-readable media.

While the machine-readable storage medium 822 is shown in an example embodiment to be a single medium, the term “machine-readable storage medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

Transmission Medium

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the, broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed. Description, therefore, is not to be taken in a limiting sense, and the scope of various embodiments is defined only by the appended claims, along with the fill range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention, in general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A system comprising:
at least one processor and storage configured to
receive registration image information from a user; and
receive information regarding a selected item from the user;
responsive to receiving the information regarding the selected item, the at least one processor further to obtain an image of the selected item, the image of the selected item produced by a manufacturer in response to the manufacturer receiving at least part of the information that was received from the user regarding the selected item;
the at least one processor further to superimpose the image information about the selected item on the registration image information to obtain a superimposed image, and
transmit the superimposed image to the user for use in deciding whether to purchase the selected item.

2. The system of claim 1 wherein the registration information comprises one of the group consisting of an image of the user wearing an article of clothing and dimensions of the user.

3. The system of claim 1 wherein the information regarding a selected item from the user comprises one of the group consisting of an image of the selected item and identification information for the selected item.

4. The system of claim 3 wherein the identification information comprising at least one of the group consisting of brand information, size information, and style information.

5. (canceled)

6. (canceled)

7. (canceled)

8. The system of claim 1 wherein the information regarding a selected item from the user is one of the group consisting of an image of the selected item taken in a bricks and mortar store and an image of the selected item retrieved from the Internet.

9. A machine-readable storage device having embedded therein a set of instructions which, when executed by a machine, causes execution of the operations comprising:
receiving registration image information from a user;
receiving information regarding a selected item from the user;
responsive to receiving the information regarding a selected item, obtaining an image of the selected item, the image of the selected item produced by a manufacturer in response to the manufacturer receiving at least part of the information that was received from the user regarding the selected item;
superimposing the image information about the selected item on the registration image information to obtain a superimposed image, and
transmitting the superimposed image to the user for use in deciding whether to purchase the selected item.

10. The machine-readable storage device of claim 9 wherein the registration information comprises one of the group consisting of an image of the user wearing an article of clothing and dimensions of the user.

11. The machine-readable storage device of claim 9 wherein the information regarding a selected item from the user comprises one of the group consisting of an image of the selected item and identification information for the selected item.

12. The machine-readable storage device of claim 11 wherein the identification information comprising at least one of the group consisting of brand information, size information, and style information.

13. (canceled)

14. (canceled)

15. (canceled)

16. The machine-readable storage device of claim 9 wherein the information regarding a selected item from the user is one of the group consisting of an image of the selected item taken in bricks and mortar store and an image of the selected item retrieved from the Internet.

17. A method comprising:
receiving, by at least one processor and storage, registration image information from a user;
receiving information regarding a selected item from the user;
responsive to receiving the information regarding a selected item, obtaining an image of the selected item, the image of the selected item produced by a manufacturer in response to the manufacturer receiving at least part of the information that was received from the user regarding the selected item;
superimposing the image information about the selected item on the registration image information to obtain a superimposed image, and
transmitting the superimposed image to the user for use in deciding whether to purchase the selected item.

18. The method of claim 17 wherein the registration information comprises one of the group consisting of an image of the user wearing an article of clothing and dimensions of the user.

19. The method of claim 17 wherein the information regarding a selected item from the user comprises one of the group consisting of an image of the selected item and identification information for the selected item.

20. The method of claim 19 wherein the identification information comprising at least one of the group consisting of brand information, size information, and style information.

21. (canceled)

22. (canceled)

23. (canceled)

24. The method of claim 17 wherein the information regarding a selected item from the user is one of the group consisting of an image of the selected item taken in bricks and mortar store and an image of the selected item retrieved from the Internet.
